(19) United States
(12) Patent Application Publication
(10) Pub. No.: US 2009/0077226 A1
(43) Pub. Date: Mar. 19, 2009

(54) METHOD AND SYSTEM OF AUTO-MONITORING NETWORK PORTS

(75) Inventors: CHING-HSIANG LEE, TAIPEI (TW); CHIH-CHIANG CHOU, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: AZUREWAVE TECHNOLOGIES, INC., TAIPEI (TW)

(21) Appl. No.: 11/856,213

(22) Filed: Sep. 17, 2007

(51) Int. Cl. G06F 15/173

(52) U.S. Cl. 709/224

(57) ABSTRACT

A method of auto-monitoring network ports includes the steps of: receiving at least one path of an application program; detecting whether or not the application program represented by the received path needs at least one network port; notifying a router to open the relative network port required by the application program if the detecting result indicates that the application program needs the network port; and notifying the router to close the relative network port required by the application program if the detecting result indicates that the application program no longer needs the network port. Hence, the present invention can achieve the purpose of exempting users from a mandatory setup of network ports for the router according to different application programs.

### BACKGROUND OF THE INVENTION

1. Field of the Invention

The present invention relates to a method and a system of auto-monitoring network ports, and more particular to a method and a system of notifying a router to set up a relative network port according to the requirements of an application program.

2. Description of Related Art

Network technology advances rapidly from the original cable network to the increasingly popular wireless network and brings us tremendous convenience of the fast transmission of information. In the structure of a network environment, a router can be used for sharing a wideband circuit for a network connection of several computers in the network environment and providing basic firewall functions, and thus router is one of the essential devices for constructing local area network. At present, wireless broadband routers are more popular and extensively used.

In addition to the construction of hardware architecture, a network also needs a setup to comply with different user requirements, so that the benefits of a network function can be maximized. In a basic router setup, it is necessary to set a firewall control and a bandwidth allocation based on the application programs used.

At present, the most commonly used interface for setting a router generally allows users to set an IP address, a port, a firewall, and etc through an internet browser (or Web Page) or an interface program. The setup interface designed by router manufacturers usually provides a list of frequently used application programs for users to choose and allows users to set the IP address, port or firewall to the application program. However, users do not know the port required by the application program easily and correctly and have no way of performing the related setup, if the application program is not in the list provided by the aforementioned conventional setup method. Furthermore, the conventional router setup method is applicable only for application programs that use a fixed port. If users use an application program that adopts a dynamic port design, the foregoing method cannot support the related setup, and users have to perform the required setup every time before they can use the application program.

To improve the efficiency of a router setup, another prior art designs a router based on the Internet Gateway Device (IGD) standard of the Universal Plug and Play (UPnP) Forum, but the application programs have to support the standard before the effect of automatically setting the related ports can be achieved. However, a vast majority of application programs still do not support the standard, and the standard can only open a port by the unlimited-time method. In other words, the router cannot control the opening time of the port. Furthermore, the standard can only support a port forwarding function, but it cannot support related controls such as a bandwidth control or even an access control.

Obviously, the conventional router setup methods require improvements.

### SUMMARY OF THE INVENTION

In view of the foregoing shortcoming of the prior art, it is a primary objective of the present invention to allow users to add a desired application program into an operation mechanism through the operation mechanism of a monitoring program, so that a router can be notified automatically according to a network port required by the application program, and the router can open or close the relative network port required by the application program. The invention exempts users from performing a mandatory complicated network port setup to the router for different application programs, and thus the invention concurrently has the advantages in the aspects of convenience, flexibility and security.

To achieve the foregoing objective, the present invention provides a method of auto-monitoring network ports comprising the steps of: receiving an input of at least one path of an application program; detecting whether or not at least one network port is needed when the application program represented by the path is executed; and notifying a router to open a relative network port if the application program requires the network port, or on the other hand, notifying a router to close a relative network port of the application program if the detecting result indicates that the application program no longer needs the network port.

To achieve the foregoing objective, the present invention provides a system of auto-monitoring network ports that comprises a router and at least one main system. The router is provided for connecting the Internet, and the main system executes at least one application program, and connects to the router. The main system further comprises a storage device for storing a monitoring program, such that when the monitoring program is executed by the main system, an input of a path of an application program is received, and the monitoring program detects whether or not an application program represented by the received path needs at least one network port when the application program is executed in order to notify a router to control, open or close a relative network port. If the monitoring program detects that the application program needs a network port, the monitoring program will notify the router to open the relative network port required by the application program; and if the monitoring program detects that the application program no longer needs the network port, the monitoring program will notify the router to close the relative network port required by the application program. Therefore, the invention allows users to perform a router setup for the application program by a simple operation procedure.

To make it easier for our examiner to understand the innovative features and technical content, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 is a block diagram of a system of auto-monitoring network ports in accordance with a preferred embodiment of the present invention;

FIG. 2A is a schematic view of types of services in a network communication protocol packet header;

FIG. 2B is a schematic view of a network tag frame;

FIG. 3 is a flow chart of controlling the bandwidth precedence in accordance with a preferred embodiment of the present invention;

FIG. 4 is a flow chart of a method of auto-monitoring network ports in accordance with a preferred embodiment of the present invention; and

FIG. 5 is a schematic view of a setup screen of menu a monitoring program in accordance with the present invention.

### DETAILED DESCRIPTION OF THE PREFERRED EMBODIMENTS

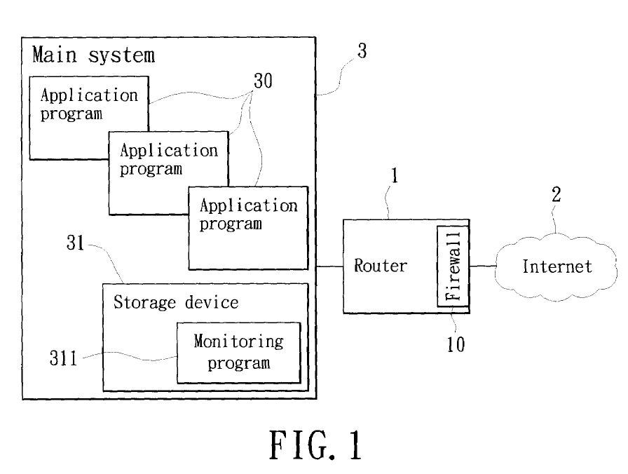

Referring to FIG. 1 for a block diagram of a system of auto-monitoring network ports in accordance with a preferred embodiment of the present invention, the present invention provides a system of auto-monitoring network ports, comprising: a router 1 and at least one main system 3. The main system 3 is connected to the router 1, and the router 1 is provided for connecting the Internet 2. Users can execute at least one application program 30 in the main system 3, so that the application program 30 can transmit data with the Internet 2 via the router 1.

The main system 3 further comprises a storage device 31 for storing a monitoring program 311, and the monitoring program 311 is executed by the main system 3, and users can input a path of the application program 30 into the monitoring program 311. The monitoring program 311 detects whether or not the application program 30 represented by the path needs at least one network port when the main system 3 executes the application program in order to notify the router 1 to control, open or close the relative network port. The storage device 31 is connected to the main system 3 by a built-in or external connection method.

Since the network port required by each application program 30 is not necessary to be the same, and the quantity of required network ports is not fixed, both of the above are determined by the protocol and specification of the application program 30, and the default settings of the application program 30 are generally used. Of course, users can also set the application program 30 manually. Regardless of using the default settings or user defined settings of the application program 30, the monitoring program 311 of the invention will not be affected, because the monitoring program 311 is provided for detecting the required setup to open a network port for the application program 30 and notifying the router 1 to close the relative network port automatically. Users do not have to perform the related network port setup at the router 1 individually for the application programs 30 used.

In other words, if the monitoring program 311 detects that the application program 30 needs a network port, the monitoring program 311 will notify the router 1 to open a relative network port required by the application program 30; on the contrary, if the monitoring program 311 detects that the application program 30 no longer needs a network port, the monitoring program 311 will notify the router 1 to close the relative network port required by the application program 30.

The monitoring program 311 further comprises at least one path list for storing a path of the application program 30, and detecting whether or not the application program 30 represented by the path in the path list needs a network port. The path list includes a bandwidth management priority list, a firewall setup list and an access control list, etc. If a user adds the path of the application program 30 to a different path list, the monitoring program 311 will perform a different control action of the network port for the application program 30 in the path list according to the functions of the different path list.

If a user adds a plurality of paths of the application programs 30 to a bandwidth management priority list, the monitoring program 311 will notify router 1 to open the relative network ports required by the application program 30 according to priority levels of the application programs 30 stored in the bandwidth management priority list, and also allows the relative network ports required by different application programs 30 to have different bandwidth utilization precedences. The priority level of the application program 30 is determined and assigned by users according to the application program 30.

In other words, when all application programs 30 represented by the paths stored in the bandwidth management priority list have been executed, the monitoring program 311 will notify the router 1 to open a bandwidth to the relative network port required by the application program 30 with the highest priority first according to the priority level of the application program 30, and so forth, such that different application programs 30 of different priorities have different bandwidth utilization precedences. Users can set the application program 30 which does not need immediate network resources to a lowest priority, and the router 1 can allocate the bandwidth to the relative network port required by the application program 30 with a low priority list, so as to release the bandwidth for the use by an application program 30 with a higher priority. If a user adds a plurality of paths of the application programs 30 to a bandwidth management priority list, the user can directly assign different priorities to different application programs 30, so that the monitoring program 311 can notify the router 1 to control the bandwidth utilization precedence as well as performing the following.

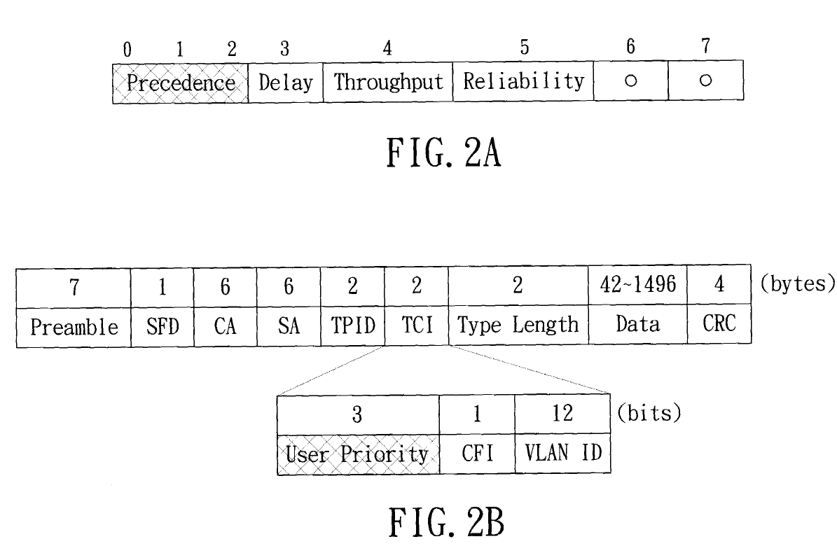

Besides, the monitoring program 311 also can add a specific mark into a network packet sent from an application program 30 according to the priority levels of the application programs 30 stored in the bandwidth management priority list, and thus the router 1 only identifies the network packet having the specific mark to automatically allocate a bandwidth for the use by the application program 30 corresponding to the network packet having the specific mark based on the specific mark. Referring to FIGS. 2A and 2B for specific marks, the specific marks are type of service precedence fields in a network communication protocol (IP) packet header or user priority fields in a network tag frame (IEEE 802.1p or IEEE 802.1Q).

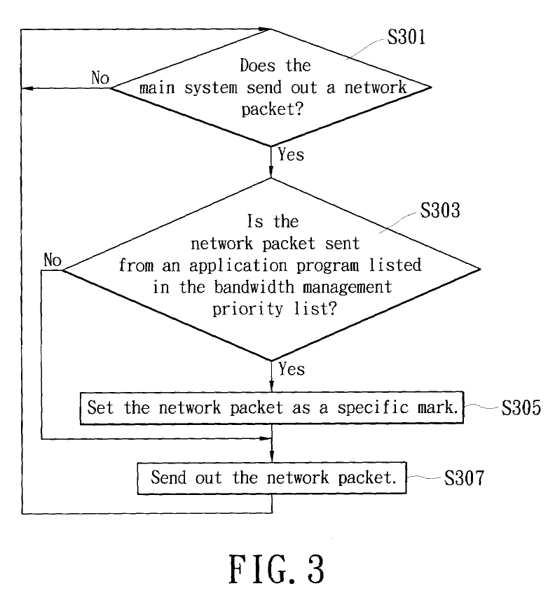

Referring to FIG. 3 for a flow chart of controlling the bandwidth precedence in accordance with a preferred embodiment of the present invention, the technical content of adding the specific mark to a network packet sent by the application program 30 is described in details here. If a user adds a plurality of paths of the application programs 30 to a bandwidth management priority list, the monitoring program 311 will detect whether or not the main system 3 sends out any network packet (S301), and if the detecting result of Step (S301) is affirmative, then the monitoring program 311 will further determine whether or not the network packet sent by the main system 3 is sent by the application program 30 in the bandwidth management priority list (S303). If the determination result of Step (S303) is affirmative, then the monitoring program 311 will set the network packet with the specific mark according to the priority level of the application program 30 in the bandwidth management priority list (S305), and the main system 3 will send a network packet to the router 1 (S307).

If the determination result of Step (S303) is negative, then it shows that the network packet currently sent by the main system 3 is not from the desired application program 30 monitored by the user, and thus it is not necessary for the monitoring program 311 to set the network packet with a specific mark, but directly carry out Step (S307), so that the main system 3 sends the network packet to the router 1. If Step (S307) is terminated or the detecting result of Step (S301) is negative, Step (S301) will be repeated to carrying out the process of detecting whether or not the main system 3 needs to send a network packet. When a user adds a plurality of paths of the application programs 30 to a bandwidth management priority list, the monitoring program 311 at any time can monitor the network packet sent from the main system 3.

If the user adds a path of an application program 30 to a firewall setup list, the monitoring program 311 will detect a network port required by the application program 30 represented by the path and stored in the firewall list to notify the router 1 to open an admitted network port in a firewall 10, such that users on the Internet 2 can pass through the firewall 10 and enter into the application program 30 via the admitted network port. As a result, user simply need to add an application program 30 opened for the access by external users on the Internet 2 to the firewall setup list, and the router 1 will open the relative admitted network port according to the application program 30, or else the external users on the Internet 2 will be blocked by the firewall 10 when they enter into the main system 3. If the monitoring program 311 detects that the application program 30 is terminated, or paused, or the network port is no longer needed, the monitoring program 311 will notify the router 1 to automatically close the relative admitted network port in the firewall 10 to prevent malicious intrusions conducted by users on the Internet 2 and improve the security.

If a user adds a path of an application program 30 to the access control list, the monitoring program 311 will notify and limit the router 1 to open the relative network port required by the application program 30 only. Now, other application programs 30 that are not added to the access control list by the user cannot be connected to the Internet 2 for their use. In addition, the access control list further comprises a plurality of fields including a domain parameter, a website parameter and a time parameter for users to perform a setup. After the user has set the aforementioned parameters, the monitoring program 311 will notice the router 1 to open the relative network port required by the application program 30 only within the time parameter, and limit the network port opened by the router 1 to be connected to the content set by the domain parameter and/or the website parameter only.

It is noteworthy to point out that the monitoring program 311 further includes a password verification mechanism for the security purpose, and thus it is necessary to perform a password verification whenever the monitoring program 311 is executed by the main system 3. After the password verification is passed, a user can run or set up the monitoring program 311. In addition, if several main systems 3 are connected to the router 1 at the same time, then the router 1 will base on the mechanism of different main systems 3 having different IP addresses to receive and identify the notice of monitoring program 311 on different main systems 3, and control the relative network ports.

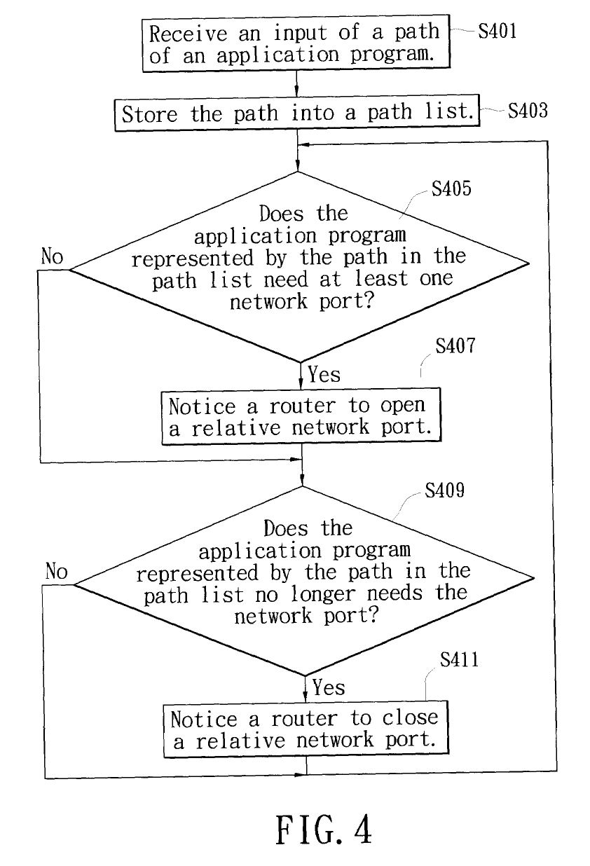

Referring to FIG. 4 for a flow chart of a method of auto-monitoring network ports in accordance with a preferred embodiment of the present invention, the present invention provides a method of auto-monitoring network ports comprising the following steps: The monitoring program 311 receives an input of a path of a desired application program 30 monitored by a user (S401), and stores the path into different path lists according to a desired control of a network port for performing different functions (S403).

And then, the monitoring program 311 will at any time detect whether or not the current application program 30 represented by a path in the path list needs a network port (S405). If the detecting result of Step (S405) is affirmative, then it indicates that the application program 30 has been executed by the main system 3, and a network port is needed for connecting the Internet 2, and thus the monitoring program 311 will notify the router 1 to open a relative network port required by the application program 30 (S407).

After the router 1 opens the relative network port required by the application program 30 in Step (S407) or the determination result of Step (S405) is negative, the monitoring program 311 will detect whether the application program 30 represent by the path stored in the path list no longer needs the network port (S409). If the detecting result of Step (S409) is affirmative, then it indicates that the application program 30 is terminated or the currently executed application program 30 no longer needs the network port, and then the monitoring program 311 will notify the router 1 to close the relative network port required by the application program 30 (S411). If the detecting result of Step (S409) is negative, or after Step (S411) is executed, the monitoring program 311 will return to Step (S405) to continue detecting whether or not the application program 30 represented by the path stored in the path list has a need for the network port. As long as the monitoring program 311 remains at its operating status, the monitoring program 311 will monitor whether or not the application program 30 represented by the path stored in the path list has a need for the network port at any time, and notify the router 1 to make adjustments.

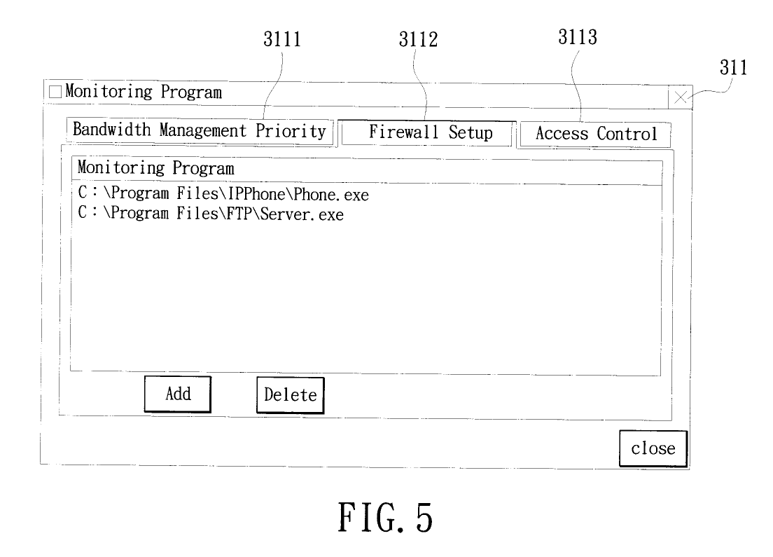

Referring to FIG. 5 for a schematic view of a screen of setting a monitoring program in accordance with a preferred embodiment of the present invention, the monitoring program 311 includes but not limited to a bandwidth management priority list 3111, a firewall setup list 3112 and an access control list 3113, and this schematic diagram illustrates the situation when the monitoring program 311 opens a firewall setup list 3112. The paths (respectively C:\Program Files\IPPhone\Phone.exe and C:\Program Files\FTP\Server.exe) of two application programs 30 are added to the firewall setup list 3112, such that when the monitoring program 311 detects that the foregoing two application programs 30 are executed by the main system 3 and there is a need for a network port, the monitoring program 311 will notify the router 1 to open an admitted network port in the firewall 10 for opening the relative network ports required by the foregoing two application programs 30, so that the foregoing two application programs 30 will not be restricted by the firewall 10, nor allow external users on the Internet 2 to enter and access the application programs.

In summation of the description above, the present invention adopts an operation mechanism of the monitoring program to allow users to control, set up or add application program into the monitoring program, so that the monitoring program notify the router to open or close the relative network port required by the application program according to the network port setup required by the application program, so as to exempt users from a mandatory complicated setup of network ports for the router according to different application programs. In addition, the present invention supports various application programs as well as network ports dynamically required by the application programs, so that when the application program no longer needs the network port, the router will close the network port automatically to prevent hackers from scanning the network port, and the router does not required expensive high-speed processors to analyze the network packets, but it simply needs to follow the notification by the monitoring program to adjust the setup of relative network ports. The invention further provides better convenience, flexibility and security.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of auto-monitoring network ports, comprising the steps:
receiving an input of at least one path of an application program;
detecting whether or not at least one network port is needed when the application program represented by the path is executed; and
notifying a router to open a relative network port, if the application program requires the network port.

2. The method of auto-monitoring network ports as recited in claim 1, further comprising a step of storing the path of an application program in at least one path list, so that the detection step detects whether or not the application program represented by the path stored in the path list needs the network port.

3. The method of auto-monitoring network ports as recited in claim 2, wherein the path list is a bandwidth management priority list.

4. The method of auto-monitoring network ports as recited in claim 3, wherein when the path of an application program is stored in the bandwidth management priority list, the bandwidth management priority list notifies the router according to priority levels of the stored application programs, such that the router can control different bandwidth utilization precedences of the relative network ports required by the application programs.

5. The method of auto-monitoring network ports as recited in claim 3, wherein when the path of an application program is stored in the bandwidth management priority list, adding a specific mark to the network packet sent by the application program according to priority levels of the stored application programs, such that the router can identify the network packets sent by the application programs to control different bandwidth utilization precedences of the network packets sent by the application programs.

6. The method of auto-monitoring network ports as recited in claim 5, wherein the specific mark is a type of service precedence field in network communication protocol (IP) packet header.

7. The method of auto-monitoring network ports as recited in claim 5, wherein the specific mark is a user priority field in a network tag frame (IEEE 802.1p or IEEE 802.1Q).

8. The method of auto-monitoring network ports as recited in claim 2, wherein the path list is a firewall setup list.

9. The method of auto-monitoring network ports as recited in claim 8, wherein when the path of an application program is stored in the firewall setup list, the router is notified to open the relative admitted network port in a firewall according to the relative network port required by the application program, and the router is notified to close the relative admitted network port in a firewall if the application program no longer needs the network port.

10. The method of auto-monitoring network ports as recited in claim 2, wherein the path list is an access control list.

11. The method of auto-monitoring network ports as recited in claim 10, wherein when the path of an application program is stored in the access control list, the router is notified and limited to open the relative network port only according to the relative network port required by the application program.

12. The method of auto-monitoring network ports as recited in claim 11, further comprising a step of setting a domain parameter, a website parameter and a time parameter in the access control list, such that the router can open the relative network port required by the application program within the time parameter, and limit the opened network port to be connected to contents of the domain parameter and the website parameter only.

13. The method of auto-monitoring network ports as recited in claim 1, further comprising a step of notifying the router to close the relative network port, after the router has opened the relative network port required by the application program, and when the detection result shows that the application program no longer needs the network port.

14. A system of auto-monitoring network ports, comprising:
a router, for connecting an Internet; and
at least one main system, for executing at least one application program, and connecting the router, and the main system further comprising:
a storage device, for storing a monitoring program, and receiving an input of the path of an application program by the monitoring program when the main system executes the monitoring program, and detecting whether or not the application program represented by the received path needs at least one network port when the application program is executed, so as to notify the router to control to open or close the relative network port;
wherein, if the monitoring program detects that the application program needs the network port, the monitoring program will notify the router to open the relative network port required by the application program; and if the monitoring program detects that the application program no longer needs the network port, the monitoring program will notify the router to close the relative network port required by the application program.

15. The system of auto-monitoring network ports as recited in claim 14, wherein the monitoring program further comprises at least one path list for storing the path of an application program, and detecting whether or not the application program represented by the path stored in the path list needs the network port.

16. The system of auto-monitoring network ports as recited in claim 15, wherein the path list is a bandwidth management priority list.

17. The system of auto-monitoring network ports as recited in claim 16, wherein when the path of an application program is stored in the bandwidth management priority list, the monitoring program notifies the router according to priority levels of the application programs stored in the bandwidth management priority list, such that the router can control different bandwidth utilization precedences of the relative network ports required by the application programs.

18. The system of auto-monitoring network ports as recited in claim 16, wherein when the path of an application program is stored in the bandwidth management priority list, the monitoring program adds a specific mark into a network packet sent from the application program according to priority levels of the application programs stored in the bandwidth management priority list, such that the router can identify the network packets sent from the application programs to control different bandwidth utilization precedences of network packets sent by the application programs.

19. The system of auto-monitoring network ports as recited in claim 18, wherein the specific mark is a type of service precedence field in a network communication protocol (IP) packet header.

20. The system of auto-monitoring network ports as recited in claim 18, wherein the specific mark is a user priority field in a network tag frame (IEEE 802.1p or IEEE 802.1Q).

21. The system of auto-monitoring network ports as recited in claim 15, wherein the path list is a firewall setup list.

22. The system of auto-monitoring network ports as recited in claim 21, wherein when the path of an application program is stored in the firewall setup list, the monitoring program notifies the router to close a relative admitted network port in a firewall according to the relative network port required by the application program.

23. The system of auto-monitoring network ports as recited in claim 15, wherein the path list is an access control list.

24. The system of auto-monitoring network ports as recited in claim 23, wherein the monitoring program notifies and limits the router to open a relative network port only according to the relative network port required by the application program, when the path of an application program is stored in the access control list.

25. The system of auto-monitoring network ports as recited in claim 24, wherein the access control list further comprises setup fields for a domain parameter, a website parameter and a time parameter, such that the monitoring program under the time parameter notifies the router to open the relative network port required by the application program, and limits the opened network port to be connected to the contents of the domain parameter and the website parameter only.

26. The system of auto-monitoring network ports as recited in claim 14, wherein the storage device is built in the main system or externally connected to the main system.

27. The system of auto-monitoring network ports as recited in claim 14, wherein the monitoring program further comprises a password verification mechanism for performing a verification when the monitoring program is executed by the main system.
